(19) United States
(12) Patent Application Publication
(10) Pub. No.: US 2023/0257546 A1
(43) Pub. Date: Aug. 17, 2023

(54) REUSE OF BIOPLASTICS IN POLYMERISATION

(71) Applicant: NOVAMONT S.P.A., Novara (IT)

(72) Inventors: Catia BASTIOLI, Novara (IT); Roberto VALLERO, Borgo D' Ale (VC) (IT)

(21) Appl. No.: 18/005,414

(22) PCT Filed: Jul. 14, 2021
(86) PCT No.: PCT/EP2021/069653

§ 371 Date: Jan. 13, 2023

(30) Foreign Application Priority Data
Jul. 15, 2020 (IT) 10202000001718

(51) Int. Cl. C08J 11/14

(52) U.S. Cl. CPC C08J 11/14; C08J 2367/02

(57) ABSTRACT

The present invention relates to a process for the reuse in polymerization of a biodegradable polymeric composition re) comprising a mixture of polyesters. The process comprises the steps of: 1) reacting said polymeric composition with water at a temperature higher than the melting temperature of at least one of said polyesters, obtaining a depolymerization product comprising monomers of said polyesters and/or their oligomers in a mixture, 2) separating from said depolymerization product a fraction comprising impurities and/or fillers, 3) subjecting said monomers and/or oligomers to polymerization, in quantities from 1% to 100% by weight, with respect to the mixture subjected to polymerization, obtaining a polymeric composition biodegradable. Further objects of the invention are the polymers obtained by means of said reuse process, the biodegradable polymeric compositions that comprise said polymers and the biodegradable articles obtained from said composition

The present invention relates to a process for polymerising monomers and/or oligomers resulting from the depolymerisation of bioplastics, in particular biodegradable compositions comprising biopolymers such as, for example, polyhydroxyalkanoates and diacid-diol polyesters.

The term biopolymers generally refers to biodegradable and/or biobased polymers. Biodegradable polymers are polymers that are able to degrade and be recycled organically once they have reached the end of their primary use by feeding microorganisms without generating an accumulation of waste in the environment. Biobased polymers are defined as those obtained from natural or renewable resources, i.e. from sources that, by their very nature, are regenerable within the time scale of human life.

In view of the widespread use of bioplastics as an alternative to conventional plastics, a further increase in sustainability could be achieved by increasing the possibility of reusing their monomers. This would minimise the use of land and the production of renewable CO₂ with a net carbon sink effect by transforming waste into fertile humus without the risk of the accumulation of any persistent substance in the environment, creating a truly circular economy. Furthermore, some of the most commonly used biobased polymers, such as polylactic acid (PLA), although biodegradable under industrial or household composting conditions, may degrade slowly under normal conditions if disposed of in the form of thick articles. Disposing of them in large quantities, as well as wasting valuable raw materials, could therefore also have an impact on the environment.

For this reason, alongside the recycling of conventional plastics, new ways of recycling/reuse are also being considered for biopolymers.

While non-biodegradable bio-based polymers can be recycled in the recycling plants already in use for their fossil-based counterparts, biodegradable polymers require alternative and specific solutions depending on the characteristics of the polymer itself.

The main recycling technologies for biopolymers currently include sorting, mechanical recycling, chemical recycling and enzyme depolymerisation, which can be applied to post-industrial or post-consumer waste.

Processes for the mechanical recycling of biopolymers, in particular from post-industrial waste, by means of shredding, grinding and melting operations, in which the materials are reused as such, are for example known. However biopolymers such as PLA and polyhydroxyalkanoates in general are particularly sensitive to temperature and the presence of moisture, which may be caused by the presence of other components. This can lead to degradation and problems with tackiness during processing.

Such problems are also encountered in chemical recycling processes, e.g. through hydrolysis, alcoholysis or thermal depolymerisation reactions. The process described in EP 2 022 818 B1, for example, relates to the hydrolysis of PLA articles in the solid state by exposure to water-saturated steam at a temperature below the melting point of the PLA at the corresponding saturated steam pressure. This process requires careful control of temperatures and pressures to avoid bringing the material to a molten state.

Furthermore, biodegradable articles such as packaging films, bags and printed or thermoformed articles for the food service industry may consist of one or more different biodegradable compositions, arranged for example in single or multiple layers, also comprising, in addition to polyhydroxyalkanoates such as PLA, other categories of biodegradable polymers, such as diacid-diol polyesters (aliphatic and/or aliphatic-aromatic) and polymers of natural origin, together with fillers and/or other additives. Such heterogeneity makes the recycling of biodegradable compositions even more complex, since the processing conditions have to be adjusted taking into account the chemical and physical characteristics of the individual components and any resulting degradation phenomena.

For these reasons, processes have been developed, for example, for recycling PLA from waste mixtures, in which PLA is dissolved in a suitable solvent and separated (e.g. by filtration or precipitation) from other solid polymers and undissolved components. This separation allows subsequent chemical recycling of the PLA, typically through hydrolysis, alcoholysis or thermal depolymerisation reactions, carried out in the presence or absence of catalysts.

For example, patents EP 2 419 396 B1 and U.S. Pat. No. 8,431,686 relate to processes in which PLA is extracted in a solvent and subsequently subjected to hydrolysis or alcoholysis, resulting in lactic acid or lactic acid esters, respectively.

However these processes only allow the recovery of lactic acid and its derivatives, i.e. only one type of monomer, and require the use of organic solvents.

There is therefore a need for processes, possibly having a low environmental impact, that make it possible to recycle heterogeneous biodegradable compositions through reusing the different components resulting from their depolymerisation in polymerisation reactions.

To meet this requirement the Applicant has developed a process that combines the depolymerisation of biodegradable polyester mixtures with their reuse in polymerisation of the monomers and/or oligomers obtained from them.

It has in fact been surprisingly observed that by conducting the depolymerisation of said mixtures of polyesters through a hydrolysis reaction with water at a temperature higher than the melting point of at least one of said polyesters, for example 120° C. or above, and preferably 250° C. or below, a mixture of monomers and/or oligomers is obtained which, following appropriate separation of any impurities or fillers present and adjustment of the content of hydroxy acids and/or their oligomers which might be present, can be effectively subjected to subsequent repolymerisation to obtain new biodegradable polymer compositions.

The mixtures of monomers and/or oligomers obtained can advantageously be used in the production of a biodegradable polyester in amounts from 1% to 100% by weight, preferably from 2% to 50% by weight and more preferably from 5% to 30% by weight, relative to the weight of the mixture undergoing polymerisation.

It is therefore one object of the present invention to provide a process for the reuse in polymerisation of a biodegradable polymer composition comprising a mixture of polyesters, said process comprising the steps of:
1) reacting said polymer composition with water at a temperature above the melting point of at least one of said polyesters, preferably 120° C. or above, and preferably at a pressure above atmospheric pressure, resulting in a depolymerisation product comprising monomers of said polyesters and/or the oligomers thereof in a mixture,
2) separating a fraction containing impurities and/or fillers from this depolymerisation product,
3) subjecting said monomers and/or oligomers to polymerisation, in amounts from 1% to 100% by weight, preferably from 2% to 50% by weight and more preferably from 5% to 30% by weight, with respect to the mixture undergoing polymerisation, resulting in a biodegradable polymer composition.

According to a preferred aspect of the invention, said biodegradable polymer composition comprises one or more polyhydroxyalkanoates and the reaction in step 1) is carried out at a temperature above the melting point of said polyhydroxyalkanoate. According to this aspect, polymerisation step 3) is preferably conducted while maintaining the amount of hydroxyacid or oligomers thereof between 0% and 25% by weight, preferably between 2 and 15% by weight, relative to the total weight of the polymerisation mixture. By keeping the hydroxy acid content and/or that of its oligomers within these ranges, the control of the quantity of lactide developed during the polymerization and of the content of lactate units in the polymer is more manageable. The process is described in more detail below.

The biodegradable polymer composition subjected to the process according to the present invention comprises a mixture of two or more different polyesters selected from the group consisting of polyhydroxyalkanoates and diacid-diol polyesters. The latter are selected from aliphatic polyesters, aromatic polyesters, aliphatic/aromatic polyesters or mixtures thereof. Such polyesters advantageously have a melting point of 250° C. or below, preferably 200° C. or below.

According to a preferred aspect, said blend of polyesters comprises at least one polyhydroxyalkanoate (A) and at least one diacid-diol polyester (B), in any proportion; mixtures with polyhydroxyalkanoate (A) from 10% to 90% by weight and diacid-diol polyester (B) from 90% to 10% by weight of the total weight of the mixture are preferred, mixtures with polyhydroxyalkanoate (A) from 20% to 80% by weight and diacid-diol polyester (B) from 80% to 20% by weight being particularly preferred.

Said polyhydroxyalkanoate (A) is preferably selected from the group consisting of the polyesters of lactic acid, poly-ϵ-caprolactone, polyhydroxybutyrate (PHB), polyhydroxybutyrate-valerate (PHBV), polyhydroxybutyrate-propanoate, polyhydroxy-butyrate-hexanoate (PHBH), polyhydroxybutyrate-decanoate, polyhydroxybutyrate-dodecanoate, polyhydroxybutyrate-hexadecanoate, polyhydroxybutyrate-octadecanoate, poly-3-hydroxybutyrate-4-hydroxybutyrate or mixtures thereof. Preferably, the polyhydroxyalkanoate comprises at least 70% by weight of one or more lactic acid polyesters.

In a preferred embodiment, said lactic acid polyesters are selected from the group consisting of poly L-lactic acid, poly D-lactic acid, poly D-L lactic acid stereo complex, copolymers comprising more than 50% in moles of said lactic acid polyesters or mixtures thereof. Particularly preferred are lactic acid polyesters containing at least 95% by weight of repeating units derived from L-lactic or D-lactic acid or combinations thereof.

In a particularly preferred embodiment of the present invention, the lactic acid polyester comprises at least 95% w/w of units derived from L-lactic acid, ≤5% w/w of repetitive units derived from D-lactic acid and has a melting point in the range 135-175 ° C.

Said diacid-diol polyester (B) is chosen from aliphatic polyesters, aromatic polyesters, aliphatic/aromatic polyesters or mixtures thereof; preferably it is an aliphatic/aromatic polyester (B1) and/or an aliphatic polyester (B2).

In the case of aliphatic/aromatic polyester B1, this preferably includes
(a) a dicarboxylic component comprising
(a1) units derived from at least one aromatic dicarboxylic acid and
(a2) units derived from at least one saturated or unsaturated (preferably saturated) aliphatic dicarboxylic acid,
(b) a diol component comprising units derived from at least one saturated or unsaturated (preferably saturated) aliphatic diol.

The aromatic dicarboxylic acids of component al) are preferably selected from the aromatic dicarboxylic acids of the phthalic acid type, preferably terephthalic acid or isophthalic acid, more preferably terephthalic acid, and aromatic dicarboxylic heterocyclic compounds, preferably 2,5-furandicarboxylic acid, 2,4-furandicarboxylic acid, 2,3-furandicarboxylic acid, 3,4-furandicarboxylic acid, more preferably 2,5-furandicarboxylic acid, their esters, salts and mixtures.

In a preferred embodiment these aromatic dicarboxylic acids include:
1 to 99% in moles, preferably 5 to 95% and more preferably 10 to 80%, of terephthalic acid, its esters or salts;
99 to 1% in moles, preferably 95 to 5% and more preferably 90 to 20%, of 2,5-furandicarboxylic acid, its esters or salts.

The aliphatic dicarboxylic acids of component a2) are preferably selected from saturated C₂-C₂₄, preferably C₄-C₁₃, more preferably dicarboxylic acids, their C₁-C₂₄, preferably C₁-C₄, alkyl esters, their salts and mixtures thereof. Preferably the saturated aliphatic dicarboxylic acids are selected from: succinic acid, 2-ethylsuccinic acid, glutaric acid, 2-methylglutaric acid, adipic acid, pimelic acid, suberic acid, azelaic acid, sebacic acid, undecandioic acid, dodecandioic acid, brassylic acid and their C₁-C₂₄ alkyl esters. In a preferred embodiment of the present invention the saturated aliphatic dicarboxylic acids include succinic acid, adipic acid, azelaic acid, sebacic acid and mixtures thereof.

The possible unsaturated aliphatic dicarboxylic acids of component a2) are preferably selected from itaconic acid, fumaric acid, maleic acid, 4-methylene-pimelic acid, 3,4-bis(methylene) nonandioic acid, 5-methylene-nonandioic acid, their C₁-C₂₄, preferably C₁-C₄, alkyl esters, their salts and mixtures thereof. In a preferred embodiment of the present invention the unsaturated aliphatic dicarboxylic acids consist of itaconic acid or comprise mixtures comprising at least 50% in moles, preferably more than 60% in moles, more preferably more than 65% in moles of itaconic acid its C₁-C₂₄, preferably C₁-C₄, esters.

As for the saturated aliphatic diols of component b), these are preferably selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecandiol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols such as polyethylene glycol, polypropylene glycol and mixtures thereof. Preferably the diol component comprises at least 50% in moles of one or more diols selected from 1,2-ethanediol, 1,3-propanediol, 1,4-butanediol. More preferably, the diol component comprises, or consists of, 1,4-butanediol.

As regards any unsaturated aliphatic diols of component b), these are preferably selected from cis-2-buten-1 4-diol trans-2-buten-1,4-diol, cis-2-penten-1,5-diol, trans-2-penten-1,5-diol, 2-pentyn-1,5-diol, trans-2-hexen-1,6-diol, 2-hexyn-1,6-diol, trans-3-hexen-1,6-diol, 3-hexyn-1,6-diol.

In the case of an aliphatic polyester (B2), this preferably comprises:
(c) a dicarboxylic component comprising units derived from a saturated or unsaturated aliphatic dicarboxylic acid,
(d) a diol component comprising units derived from a saturated or unsaturated aliphatic diol.

The saturated aliphatic dicarboxylic acids of component c) are preferably present in an amount of 95 to 100% in moles relative to the total dicarboxylic component; they are preferably chosen from saturated C₂-C₂₄, preferably C₄-C₁₃, more preferably C₄-C₁₁, dicarboxylic acids, their C₁-C₂₄, preferably C₁-C₄, alkyl esters, their salts and mixtures thereof. Preferably the saturated aliphatic dicarboxylic acids are chosen from succinic acid, 2-ethylsuccinic acid, glutaric acid, 2-methylglutaric acid, adipic acid, pimelic acid, suberic acid, azelaic acid, sebacic acid, undecanedioic acid, dodecanedioic acid, brassylic acid, hexadecanedioic acid, octadecanedioic acid and C₁-₂₄ alkyl esters thereof. Preferably, the dicarboxylic component comprises, or consists of, units derived from succinic acid.

The possible unsaturated aliphatic dicarboxylic acids of component c) are preferably present in an amount from 0 to 5% in moles relative to the total dicarboxylic component; they are preferably chosen from itaconic acid, fumaric acid, maleic acid, 4-methyl-pimelic acid, 3,4-bis(methylene) nonandioic acid, 5-methylene-nonandioic acid, their C₁-C₂₄, preferably C₁-C₄, alkyl esters, their salts and mixtures thereof. In a preferred embodiment of the present invention the unsaturated aliphatic dicarboxylic acids comprise itaconic acid or comprise mixtures comprising at least 50% in moles, preferably more than 60% in moles, more preferably more than 65% in moles, of itaconic acid and its C₁-C₂₄, preferably C₁-C₄, esters.

As for the saturated aliphatic diols in component d), these are preferably present in amounts from 95 to 100% in moles relative to the total diol component; they are preferably selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cycloalkylenedimethanol, neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols having a molecular weight of 100-4000, such as polyethylene glycol, polypropylene glycol and mixtures thereof. Preferably the diol component comprises at least 50% in moles of one or more diols selected from 1,2-ethanediol, 1,3-propanediol, 1,4-butanediol. More preferably the diol component comprises or consists of 1,4-butanediol.

As for the unsaturated aliphatic diols of component d2), these are preferably present in amounts from 0 to 5% in moles relative to the total diol component; they are preferably selected from cis 2-buten-1,4-diol, trans-2-buten-1,4-diol, 2-butyn-1,4-diol, cis-2-penten-1,5-diol, trans-2-penten-1,5-diol, 2-pentyn-1,5-diol, cis-2-hexen-1,6-diol, trans-2-hexen-1,6-diol, 2-hexyn-1,6-diol, cis-3-hexen-1,6-diol, trans-3-hexen-1,6-diol, 3-hexyn-1,6-diol.

In a particularly preferred embodiment the biodegradable composition fed to the process according to the present invention comprises one or more diacid-diol (B) polyesters selected from the group consisting of: poly(1,4-butylene succinate), poly(1,4-butylene succinate-co-1,4-butylene adipate), poly(l,4-butylene succinate-co-1,4-butylene azelate), poly(l,4-butylene adipate-co-1,4-butylene terephthalate), poly(1,4-butylene succinate-co-1,4-butylene terephthalate), poly(l,4-butylene azelate-co-1,4-butylene terephthalate), poly(1,4-butylene brassylate-co-1,4-butylene terephthalate), poly(l,4-butylene sebacate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butylene adipate-co-1,4-butylene azelate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene succinate-co-1,4-butylene terephthalate) and mixtures thereof.

The aliphatic and/or aliphatic/aromatic polyesters (referred to as diacid-diol polyester (B)) in the biodegradable composition subjected to the process according to the present invention may further comprise repeating units derived from at least one hydroxy acid in an amount of, for example, between 0 and 49%, preferably between 0 and 30%, in moles relative to the total moles of the dicarboxylic component. Examples of convenient hydroxy acids are glycolic acid, hydroxybutyric acid, hydroxycaproic acid, hydroxyvaleric acid, 7-hydroxyheptanoic acid, 8-hydroxycaproic acid, 9-hydroxynonanoic acid, lactic acid or lactides.

Long molecules containing two functional groups, which need not be terminal functional groups, may also be present, typically in amounts of no more than 10% in moles of the total moles of dicarboxylic component. Examples are dimer acids, ricinoleic acid and acids bearing epoxy functional groups and also polyoxyethylenes with molecular weights between 200 and 10000.

Diamines, amino acids, amino alcohols may also be present in percentages of up to 30% of the total moles of the dicarboxylic component.

In addition, one or more polyfunctional molecules may be present, typically in amounts between 0.01 and 3% in moles in relation to the total moles of dicarboxylic component. Examples of such molecules are glycerol, pentaerythritol, trimethylolpropane, citric acid, dipentaerythritol, monoanhydrosorbitol, monoanhydromannitol, acid triglycerides, polyglycerols, etc.

The biodegradable polymer composition subjected to the process according to the present invention also optionally comprises one or more polymers of natural origin.

This polymer of natural origin is advantageously selected from starch, chitin, chitosan, alginates, proteins such as gluten, zein, casein, collagen, gelatine, natural gums, cellulose (also in nanofibrils) and pectin.

The term starch is used here to refer to all types of starch, i.e. flour, native starch, hydrolysed starch, destructured starch, gelatinised starch, plasticised starch, thermoplastic starch, biofillers comprising complexed starch or mixtures thereof. Typically present in biodegradable compositions are starches such as potato, maize, tapioca and pea starches. Included in the definition are starches capable of being easily deconstructed and having high initial molecular weights, such as potato or maize starch.

The starch may be present either as such or in a chemically modified form, such as starch esters having a level of substitution between 0.2 and 2.5, hydroxypropylated starch, or starch modified with fat chains. By unstructured starch, reference is made herein to the teachings contained in Patents EP-0 118240 and EP-0 327 505, starch being understood to be starch processed in such a way that it does not substantially show the so-called “maltese crosses” under the optical microscope in polarised light and the so-called “ghosts” under the optical microscope in phase contrast.

In the case where the biodegradable composition comprises destructured starch, it typically also comprises 1-40% by weight, relative to the weight of the starch, of one or more plasticisers chosen from water and polyols having from 2 to 22 carbon atoms. The water may also be the water naturally present in the starch. Preferred among the polyols are polyols having 1 to 20 hydroxyl groups and/or containing 2 to 6 carbon atoms, their ethers, thioethers and organic and inorganic esters. Examples of polyols include glycerol, diglycerol, polyglycerol, pentaerythritol, ethoxylated polyglycerol, ethylene glycol, polyethylene glycol, 1,2-propanediol, 1,3-propanediol, 1,4-butanediol, neopentylglycol, sorbitol, sorbitol monoacetate, sorbitol diacetate, sorbitol monoethoxylate, sorbitol diethoxylate, and mixtures thereof. Examples of mixtures comprise between 2 and 90% glycerol by weight.

The biodegradable polymer composition processed according to the present invention further optionally comprises one or more fillers or filler agents.

Said filler agent or filler is preferably selected from kaolin, wollastonite, barytes, clay, talc, calcium and magnesium carbonates, iron and lead carbonates, aluminium hydroxide, diatomaceous earth, aluminium sulfate, barium sulfate, silica, mica, titanium dioxide. &p Such filler agents, such as talc, calcium carbonate or mixtures thereof, are typically present in the form of particles having an arithmetical mean diameter of more than 1 micron, measured along the major axis of the particle.

The biodegradable polymer composition subjected to the process according to the present invention further optionally comprises one or more additional polymers other than the polyhydroxyalkanoates (A), the diacid-diol polyesters (B) and the polymers of natural origin listed above.

Said additional polymers are for example selected from the group consisting of vinyl polymers, diacid-diol polyesters other than polyester (B), polyamides, polyurethanes, polyethers, polyureas, polycarbonates and their mixtures.

Examples of vinyl polymers are: polyethylene, polypropylenes and their copolymers, polyvinyl alcohol and its copolymers such as butenediol/vinyl alcohol copolymer, polyvinyl acetate, polyethyl vinylacetate and polyethylene vinyl alcohol, polystyrene, chlorinated vinyl polymers, polyacrylates.

In addition to polyvinyl chloride, chlorinated vinyl polymers are here to be understood to include polyvinylidene chloride, poly(vinyl chloride-vinyl acetate) poly(vinyl chloride-ethylene), poly(vinyl chloride-propylene), poly(vinyl chloride-styrene), poly(vinyl chloride-isobutylene) as well as copolymers in which polyvinyl chloride represents more than 50% in moles. Said copolymers may be random, block or alternating copolymers.

With regard to the polyamides which may be present in the biodegradable composition subjected to the process according to the present invention, these are selected for example from the group consisting of polyamide 6 and 6,6, polyamide 9 and 9,9, polyamide 10 and 10,10, polyamide 11 and 11,11, polyamide 12 and 12,12 and combinations thereof of the 6/9, 6/10, 6/11, 6/12 types, their mixtures and copolymers, both random and block.

The polycarbonates which may be present are, for example, selected from the group consisting of polyalkylene carbonates, preferably polyethylene carbonates, polypropylene carbonates, polybutylene carbonates, their mixtures and both random and block copolymers.

Among the polyethers, examples are those selected from the group consisting of polyethylene glycols, polypropylene glycols, polybutylene glycols, their copolymers and their mixtures. As regards diacid-diol polyesters other than polyester (B), these include, for example:
(e) a dicarboxylic component comprising, in relation to the total of the dicarboxylic component:
   (e1) 20-100% in moles of units derived from at least one aromatic dicarboxylic acid,
   (e2) 0-80% in moles of units derived from at least one saturated or unsaturated aliphatic dicarboxylic acid,
(f) a diol component comprising units derived from at least one saturated or unsaturated aliphatic diol.

Preferably, aromatic dicarboxylic acids e1), aliphatic dicarboxylic acids e2) and aliphatic diols f) for said polyesters are selected from those described above for the polyester (B) of the composition according to the present invention.

Other examples of diacid diol polyesters other than polyester (B) are chemically modified and/or low melting point aliphatic and/or aliphatic-aromatic polyesters. Chemically modified polyesters include, for example, polyesters modified by grafting, e.g. with α,β-unsaturated monocarboxylic, α,β-unsaturated dicarboxylic acids and/or anhydrides or combinations thereof.

In addition to the above-mentioned components, the biodegradable composition according to the present invention optionally also contains one or more additives selected from the group consisting of plasticisers, UV-stabilisers, lubricants, nucleating agents, surfactants, anti-static agents, pigments, flame retardants, compatibilising agents, lignin, organic acids, antioxidants, anti-mould agents, waxes, process aids.

With respect to plasticisers, in addition to the plasticisers preferably used for the preparation of destructured starch and described above, there may be one or more plasticisers selected from the group consisting of phthalates, such as, for example, diisononyl phthalate, trimellitates, such as, for example, trimellitic acid esters with C₄-C₂₀ mono-alcohols preferably selected from the group consisting of n-octanol and n-decanol, and aliphatic esters of mono- and dicarboxylic acids with linear or branched C₂-C₈ alkenes, e.g. neopentylglycol. When present, the selected plasticisers are preferably present up to 10% by weight relative to the total weight of the composition.

The lubricants are for example zinc stearate, calcium stearate, aluminium stearate and acetyl stearate. Preferably, the composition according to the present invention comprises up to 1% by weight of lubricants, more preferably up to 0.5% by weight, relative to the total weight of the composition.

Examples of nucleating agents include saccharin sodium salt, calcium silicate, sodium benzoate, calcium titanate, boron nitride, isotactic polypropylene, low molecular weight PLA. Process aids include, for example, slip agents. Slip agents include, for example, biodegradable fatty acid amides such as oleamide, erucamide, ethylene-bis-stearylamide, fatty acid esters such as glycerol oleates or glycerol stearates, saponified fatty acids such as stearates.

Pigments may also be present, e.g. titanium dioxide, clays, copper phthalocyanine, titanium dioxide, silicates, iron oxides and hydroxides, carbon black, and magnesium oxide.

Examples of compatibilising agents are di- and/or polyfunctional compounds bearing isocyanate, peroxide, carbodiimide, isocyanurate, oxazoline, epoxide, anhydride, divinylether groups and mixtures thereof.

These additives are preferably present in quantities of up to 10% by weight and more preferably up to 6% and even more preferably up to 2% by weight, relative to the total weight of the composition.

Within the meaning of the present invention, a biodegradable composition means a polymer composition that is biodegradable according to standard EN 13432.

The biodegradable composition subjected to step 1) of the process according to the present invention preferably originates from post-industrial waste and/or post-consumer waste, for example from biodegradable articles such as packaging films, bags and printed or thermoformed food service articles in industrial waste or at the end of their life.

This waste is optionally subjected to one or more preliminary operations in order to remove organic or inorganic debris and residues, to obtain a homogeneous composition and to extend surface area to facilitate the subsequent hydrolysis reaction in step 1) of the process.

These preliminary operations are advantageously selected from the group consisting of: washing, screening, separation, comminution, conditioning.

Separation operations may be carried out e.g. manually, by density, by optical systems, by dissolution.

Comminution operations include, for example, crushing, grinding, pelletising.

According to a first embodiment of the present invention, a biodegradable composition, the polymer component of which consists of, or mainly comprises, one or more polyhydroxyalkanoates (A) and one or more aliphatic-aromatic diacid diol polyesters (B1), is fed to step 1) of the process

According to a second embodiment of the present invention, a biodegradable composition consisting of, or mainly comprising one or more polyhydroxyalkanoates (A), one or more aliphatic-aromatic diacid diol polyesters (B1) and one or more fillers is fed to step 1) of the process.

According to a third embodiment of the present invention, a biodegradable composition consisting of, or mainly comprising, one or more polyhydroxyalkanoates (A) and one or more aliphatic-type diacid diol polyesters (B2) is fed to step 1) of the process.

According to a fourth embodiment of the present invention, a biodegradable composition consisting of, or mainly comprising, one or more polyhydroxyalkanoates (A), one or more aliphatic type diacid diol polyesters (B2) and one or more fillers is fed to step 1) of the process. According to a fifth embodiment, a biodegradable composition consisting of, or mainly comprising, one or more polyhydroxyalkanoates (A), one or more aliphatic type diacid diol polyesters (B2), one or more fillers and one or more additional polymers comprising one or more vinyl polymers and one or more diacid diol polyesters other than (B) is fed to step 1) of the process.

If the biodegradable starting composition contains one or more polymers of natural origin, the process according to the present invention advantageously comprises, prior to step 1), a preliminary pre-treatment step during which said polymers of natural origin, optionally together with one or more possible fillers (organic and/or inorganic) and/or additives, are partly or completely removed.

Said preliminary pre-treatment step is advantageously carried out by dissolution or by a hydrolysis reaction (e.g. chemical hydrolysis, enzyme hydrolysis) capable of totally or partially breaking down the polymer chain of the natural polymer, e.g. the polysaccharide chain in the case of starch.

This preliminary step is carried out under lower temperature and pressure conditions than those used in step 1) of the process, preferably in the presence of water and advantageously in the presence of a catalyst such as an acid, basic or enzyme catalyst.

This pre-treatment removes other components of a polymer or non-polymer nature from the biodegradable composition that are soluble under the conditions adopted, such as certain plasticisers, in addition to the polymers of natural origin.

The soluble components are then removed following separation of the liquid phase from the solid biodegradable composition.

Complete or substantially complete removal of hydrolysis residues, which could give rise to degradation phenomena under process conditions, is preferred. Pre-treatment therefore advantageously comprises one or more washing and/or filtration operations.

In step 1) of the process according to the invention the biopolymers present in the biodegradable polymer starting composition undergo a hydrolysis reaction, i.e. cleavage of the ester bonds of the polymer chains, until mixtures of oligomers and/or monomers are formed.

The hydrolysis reaction requires the presence of water and appropriate temperature, pH and pressure conditions. Depending on the reaction conditions and the amount of water used, the hydrolysis reaction will result in cleavage of the polymer chains to obtain monomer units, e.g. hydroxy acids, dicarboxylic acids and diols (total hydrolysis), or partial cleavage into oligomers or a mixture of monomers and oligomers (partial hydrolysis).

The hydrolysis reaction in step 1) is carried out with water at a temperature above the melting point of at least one of said polyesters and preferably at a pressure above atmospheric pressure. The reaction in step 1) is therefore preferably carried out in equipment suitable for the processing of fluids, including those having high viscosity. For example, reactors which allow effective mixing, adequate heat exchange surfaces and high pressures to be obtained, such as autoclaves, preferably equipped with an agitation system, or extruders, will preferably be used. Reactors capable of ensuring an adequate contact surface between the polymer melt and the vapour phase will also be preferred.

One or more reactors, which are the same or different from each other, may be used in series. The starting biodegradable polymer composition is placed in contact with water in such quantities as to achieve a weight ratio of water to polymer composition that is advantageously between 3:1 and 1:2, preferably between 2.5:1 and 1:1.5, even more preferably between 2:1 and 1:1.

The water and the polymer composition are advantageously placed in contact at room temperature or at least at a temperature below the reaction temperature. Heating to the reaction temperature is therefore preferably carried out in the presence of water.

The temperature during the hydrolysis reaction is maintained above 120° C., preferably at 150° or above, more preferably 170° C. or above and even more preferably 200° C. or above, and advantageously 250° C. or below, preferably 240° C. or below and more preferably 230° C. or below. These conditions are particularly advantageous in that they make it possible to work even in the absence of catalysts.

According to one aspect of the invention in which a biodegradable composition comprising a mixture of aromatic aliphatic (B1) and/or aliphatic (B2) type diacid diol polyesters containing units derived from succinic acid, such as polybutylene succinate and/or copolymers thereof, is fed to hydrolysis step 1), the temperature is advantageously maintained between 120° C. and 200° C. Losses of 1,4-butandiol due to the increase in its cyclization products such as tetrahydrofuran can be observed at higher temperatures.

The hydrolysis reaction is carried out at a pressure preferably equal to the vapour pressure of the liquid. During step 1 of the process the pressure is therefore maintained at ambient pressure (about 1 bar) or at values of 2 bar (0.2 MPa) or above, 5 bar (0.5 MPa) or above, 10 bar (1 MPa) or above or preferably 15 bar (1.5 MPa) or above, and advantageously 50 bar (5 MPa) or below, preferably 40 bar (4 MPa) or below or more preferably 30 bar (3 MPa) or below.

Compositions primarily comprising diacid-diol polyesters prepared from aliphatic dicarboxylic acids typically require lower pressure and temperature conditions than diacid-diol polyesters prepared from aliphatic and aromatic dicarboxylic acids. Those skilled in the art will therefore be able to adjust the reaction conditions within the above ranges according to the biodegradable composition fed to the process.

According to one embodiment of the process, during step 1) the hydrolysis reaction is carried out in two or more successive steps, separating out the aqueous phase containing soluble monomers and/or oligomers obtained by hydrolysis at the end of each step and feeding new water/steam to the next step. These steps may be carried out under the same pressure and temperature conditions or, according to a preferred aspect, each step is carried out under conditions of higher pressure and/or temperature than the previous step.

The duration of the hydrolysis reaction varies mainly according to the temperature and pressure conditions used and the manner of contact between water and the composition to be hydrolysed, for example from a few minutes under drastic conditions to 10 hours under milder conditions, preferably from 30 minutes to 4 hours and more preferably from 60 minutes to 3 hours. According to a preferred aspect of the invention, the reaction achieves 95% conversion in 2 hours, for example.

The hydrolysis reaction in step 1) can be facilitated by the presence of acid or basic catalysts or metal salts. Examples of suitable catalysts are mineral acids such as sulfuric acid, hydrochloric acid and phosphoric acid, bases such as alkali and alkaline earth metal oxides and hydroxides, and salts such as zinc acetate and magnesium acetate.

Basic catalysts have the advantage of allowing acid monomers that would otherwise be insoluble in water, such as furandicarboxylic acid and terephthalic acid, to pass into aqueous solution in dissociated form, thus simplifying recovery operations. The catalysts are preferably used in quantities of 0 to 1000 ppm relative to the biodegradable composition.

One of the advantages of the present process is that it can be efficiently carried out entirely in the absence of organic solvents. However, the hydrolysis reaction in step 1) may be facilitated by the presence of small amounts of water-miscible organic solvents such as ethanol, propanol, isopropanol, butanol. Where used, such solvents are advantageously removed prior to polymerisation step 3).

The depolymerisation product obtained at the end of the hydrolysis reaction comprises a mixture of the monomers of the polyesters present in the initial biodegradable composition, e.g. hydroxy acids, dicarboxylic acids and diols selected from those described above as components of the initial biodegradable composition, and/or oligomers thereof.

Said monomers are advantageously selected from the group consisting of adipic acid, azelaic acid, sebacic acid, succinic acid, terephthalic acid, furandicarboxylic acid, lactic acid, 3-hydroxybutyric acid, 3-hydroxyvaleric acid and 3-hydroxyhexanoic acid, 1,2-ethanediol, 1,3-propanediol, 1,4-butanediol.

In the meaning of the present invention the term “oligomer” means each set of repeating units in the polymer chain (i.e., hydroxyacid units or diacid-diol units) that is soluble in water, for example each set of 2, 3 or 4 repeating units. The molecular mass of an oligomer according to the invention is typically less than 2000.

Said oligomers may be present in amounts from 1 to 100% by weight of the total weight of monomers and oligomers in the depolymerisation product, preferably from 10 to 50% by weight.

In step 2) of the process a fraction comprising impurities and/or fillers is separated from the depolymerisation product. This separation is carried out according to known techniques and preferably comprises solid/liquid separation operations. Such separation enables the removal of additives that are no longer reactive, such as, for example, insoluble branching and slip agents, making the process according to the present invention particularly advantageous compared to mechanical recycling technology, in which such additives would accumulate in the polymerisation phase. According to a preferred aspect, the monomers are selectively separated in step 2), on the basis of their solubility, modulating the separation conditions.

According to one aspect of the process, the depolymerisation product comprises water-soluble monomers and/or oligomers, such as diols, hydroxy acids and aliphatic dicarboxylic acids, and possibly salts of dicarboxylic acids. On the other hand, insoluble monomers and/or oligomers such as aromatic dicarboxylic acids of the phthalic acid type in undissociated form remain in the heterogeneous phase and, once the mixture has cooled below the melting point, are in the solid state together with any insoluble fillers and/or impurities.

According to this aspect of the process, separation of step 2) is carried out after cooling the depolymerisation product to a temperature below the melting point; said soluble monomers and/or oligomers are therefore advantageously present in solution in the aqueous phase together with any soluble additives such as, for example, plasticisers, branching agents or other soluble polymers.

Step 2) of the process according to the invention thus makes it possible to separate a fraction also comprising insoluble monomers and/or oligomers and/or residues from the non-hydrolysed starting mixture, in addition to any insoluble fillers and/or impurities, from the depolymerisation product. According to another aspect of the process, for example if a limited amount of water is present or in the case of partial hydrolysis, the depolymerisation product at the end of the hydrolysis step essentially presents as a fluid mass containing fillers and/or impurities which are solid at the hydrolysis temperature. These fillers and/or impurities are then separated from said fluid mass as a solid fraction.

In this case in particular, the depolymerisation product containing monomers and/or oligomers is advantageously returned to the hydrolysis step or subsequent further purification operations (e.g. washing) before the polymerisation step in order to remove any water-soluble molecules present for example as additives in the biodegradable starting composition, such as branching agents, which could interfere in the subsequent polymerisation step.

However, one of the advantages of the present process lies in the possibility of feeding additives from the starting polyester mixture to polymerisation step 3), together with monomers and/or oligomers, in amounts of up to 5% by weight, preferably from 1 to 2% by weight, with respect to the mixture subjected to polymerisation. In fact, it is possible to reuse not only the purified monomers deriving from depolymerisation of the starting mixture, but also a partial and/or partially purified hydrolysis product, in polymerisation.

The separation operations in process step 2) are for example chosen from the group consisting of filtration, centrifuging, settling. Filtration comprises e.g. microfiltration and ultrafiltration. According to an aspect of the present invention, one or more liquid/liquid separation are performed during step 2).

Said solid fraction separated in step 2) comprises one or more components selected from fillers, non-hydrolysed or non-hydrolysable polymers, insoluble oligomers and monomers, insoluble impurities such as additives or degradation products.

At the end of step 2) the fraction of depolymerisation product comprising monomers and/or oligomers is sent to polymerisation step 3) as such or after one or more optional further separation operations to wholly or partly separate the monomers and/or oligomers from each other and/or from impurities such as heavy metals, for example.

Said optional further separation operations are for example advantageously chosen from crystallisation, distillation, microfiltration, nanofiltration, ultrafiltration, dialysis.

Crystallisation operations make it possible, for example, to separate any aliphatic acids from components with higher solubility in water such as diols and hydroxy acids. For example, succinic acid can advantageously be separated from lactic acid and butanediol by crystallisation.

Distillation operations allow monomers to be fractionated on the basis of different boiling points, but must be chosen so as to favour conditions that do not facilitate esterification side reactions between acid and hydroxyl groups in the mixture.

If acidic or basic catalysts are used during hydrolysis step 1), the fraction of the depolymerisation product separated in step 2) is also advantageously brought to neutral pH before being fed to polymerisation step 3).

In step 3) of the process, said monomers and/or oligomers obtained downstream of the separation of fillers and/or impurities are subjected to polymerisation, in amounts from 1% to 100% by weight, preferably from 2% to 50% by weight and more preferably from 5% to 30% by weight, with respect to the mixture subjected to polymerisation, obtaining a biodegradable polymer composition.

In accordance with the present invention the weight of the polymerised mixture is calculated without taking into account any solvent (e.g. water) present.

The amount of hydroxy acids or their oligomers in the polymerisation mixture is advantageously between 0% and 25% by weight, preferably between 2 and 15% by weight, relative to the total weight of the polymerisation mixture.

According to one aspect, the amount of hydroxy acid or oligomers thereof that may be present in the polymerisation mixture is maintained in the indicated range by one of the above-mentioned separation operations, for example by distillation of the hydroxy acid or oligomers thereof.

In another aspect, the amount of monomers and/or oligomers is kept in the indicated range by adding further virgin or recycled monomers to the polymerisation mixture.

Polymerisation according to the process according to the invention is carried out according to any of the processes known in the state of the art. In particular, it may advantageously be carried out by polycondensation. Examples of synthetic processes that can advantageously be used for the preparation of polyesters are described in international patent application WO 2016/050963.

The polymerisation reaction according to the invention preferably comprises:
(i) preparing of an oligomer product by a reaction to esterify and/or transesterify a mixture comprising:
   a) a dicarboxylic component comprising:
      a1) 0-80% in moles, with respect to the total dicarboxylic component, of units derived from at least one aromatic dicarboxylic acid and/or an ester, salt or derivative thereof, and
      a2) 20-100% in moles, with respect to the total dicarboxylic component, of units derived from at least one aliphatic dicarboxylic acid and/or an ester, salt or derivative thereof, and
   b) a diol component,
   c) a hydroxy acid component in an amount from 0% to 25% by weight, preferably from 2% to 15% by weight, of the total weight of said mixture,
(ii) polycondensation of the oligomer product obtained from step (i), and
(iii) granulation of the polyester obtained from step (ii).

The aromatic dicarboxylic acids, aliphatic dicarboxylic acids and diols are preferably selected from among those described above as components of the biodegradable starting composition. The synthesis process can advantageously be carried out in the presence of a suitable catalyst. Suitable catalysts include organometallic tin compounds, e.g. stannoic acid derivatives, titanium compounds, e.g. ortho-butyl titanate, aluminium compounds, e.g. Al-triisopropyl, antimony, zinc and zirconium compounds and mixtures thereof.

Such polymerisation is advantageously preceded by complete removal of water from the polymerisation mixture to avoid interference in the esterification step.

During polymerisation, branching, compatibilising or stabilising agents such as those described above are advantageously added as components of the biodegradable starting composition. The polymerisation product obtained is a biodegradable polyester and can in turn be subjected to reactive extrusion for the preparation of biodegradable polymer compositions.

The invention therefore also covers polymers obtained by the process described above.

According to a different aspect, the invention relates to a biodegradable polymer composition comprising said polymers and optionally further biodegradable polymers and additives known in the art, for example chosen from those described above for the biodegradable composition subjected to the depolymerisation process.

Said biodegradable polymer composition obtained according to the invention can be advantageously used for example in blown film-forming, cast extrusion, thermoforming or injection moulding processes, obtaining biodegradable articles with application for example in the packaging sector, the food service sector or the agri-textile sector.

According to another aspect, the invention therefore relates to biodegradable articles comprising said biodegradable polymer composition.

Examples of products comprising the composition according to the present invention are:
films, both mono and bi-oriented, and multi-layer films with other polymer materials;
films for use in the agricultural sector as mulching sheets;
fabric for use in the agricultural sector as agri-textile cloth;
films for use in the hygiene sector such as for nappies, liners for tampons, etc.
stretch film, also clingfilm, for food, for baling in agriculture and for wrapping waste;
bags and liners for organic collection such as the collection of food waste and grass cuttings;
fruit and vegetable bags and shopping bags;
coatings obtained using the extrusion coating technique;
multilayer laminates with layers of paper, plastics, aluminium, metallised films;
expanded or expandable granules for the production of formed parts by sintering;
expanded and semi-expanded products including expanded blocks made from pre-expanded particles;
expanded sheets, thermoformed expanded sheets, containers made from them for food packaging;
composites with gelatinised, destructured and/or complexed starch, natural starch, flours, other fillers of natural, vegetable or inorganic origin, as fillers;
items produced by thermoforming such as containers, trays, plates, beverage dispensing capsules and printed circuit boards for electronics.
fibres, microfibres, composite fibres, textiles and nonwovens for the health, hygiene, agricultural and clothing sectors.

### EXAMPLES

### Example 1

102.5 g of a formulation consisting mainly of 78% w/w PBAT (i.e. poly(1,4-butylene adipate-co-1,4-butylene terephthalate)), 19.5% w/w PLA and 2.5% w/w talc was placed in a pressure reactor with 200 g water and heated to 200° C. This temperature was maintained for 2 hours (step 1).

After 2 hours the reactor was allowed to cool and the product was collected, heated to 60° C. to ensure complete solubility of the liberated adipic acid and then filtered under vacuum with paper using a Buchner to separate out the insoluble fraction (mainly comprising terephthalic acid and talc) (step 2).

The liquid phase, amounting to 270 g, contained mainly 1,4-butanediol, lactic acid, adipic acid, traces of dimers and linear trimers including lactate units, 1,4-butylene terephthalate and/or 1,4-butylene adipate.

HPLC-MS analysis performed using a Phenomenex Luna Omega C18 PS 100mm×2.1mm×1.6 μm column, using gradient elution with acetonitrile (A) and 0.1% formic acid in water (B), increasing the concentration of A from 5% to 95% and acquiring the signal with a mass spectrometer under positive ESI ionisation (for oligomers) and negative ESI ionisation (for acids and hydroxy acids) revealed the presence of lactic acid, adipic acid, butanediol and dimers and trimers containing lactate, 1,4-butylene adipate and/or 1,4-butylene terephthalate units. The analysis did not reveal any polymer chains with a molecular mass of more than 2,000, so it was assumed that depolymerisation was quantitative and that 25 g of lactic acid, 29.6 g of adipic acid and 34.4 g of 1,4-butanediol were present in the liquid phase as free acids or oligomers.

372.6 g (2.2445 moles) of terephthalic acid, 299.4 g (2.0507 moles) of adipic acid, 645 g (7.1633 moles) of 1,4-butanediol, 0.66 g (0.007163 moles) of glycerol, 0,25 g of Tyzor TE and 270 g of solution obtained by filtering the depolymerisation product and containing about 89 g of depolymerisation products (corresponding to 6.3% by weight of the total weight of the polymerisation mixture) were placed in a 2-litre glass reactor equipped with a mechanical stirring system, a nitrogen inlet and a distillation line with a Vigreux-type column, water coolant and a collecting flask. The lactic acid reused in the mixture therefore constituted 5.8% in moles of the total acids and hydroxy acids used, corresponding to 1.8% by weight of the total weight of the polymerisation mixture.

The reactor was immersed in an oil bath and the temperature of the oil was gradually increased to approximately 250° C. over a period of 2 hours so that a melt temperature of approximately 235° C. was reached. The esterification reaction was carried out for 4 hours, at the end of which the melt was clear. The esterification product was found to be a white waxy solid similar to that obtained from a similar mixture without introduction of the depolymerisation product.

170 g of the esterification product was placed in a 1000 ml glass conical reactor equipped with mechanical stirring, nitrogen inlet and vacuum line with a boil-over abatement system connected to a mechanical vacuum pump. The reactor was immersed in an oil bath and the esterification product (oligomer) was caused to melt under a flow of nitrogen. The oil temperature was raised to 240° C., then 0.18 g of catalyst mixture (30% w/w tetrabutyl titanate and 70% w/w tetrabutyl zirconate) was added and the vacuum was increased to less than 3 mbar over 30 minutes. The reaction was carried out at 240° C. and with a residual pressure of less than 3 mbar for 6 hours, resulting in a polyester with an MFR (190° C./2.16 kg) of 5.0 g/10 min, viscosity in solution of 1.04 dl/g (2 g/l, chloroform, 25° C.) and colour L*=67.9, colour a*=8.1 and colour b*=12.9 measured on the granule according to ASTM D6290.

1. A process for reuse in polymerisation of a biodegradable polymer composition comprising a mixture of polyesters, said process comprising the steps of:
1) reacting said polymer composition with water at a temperature above the melting point of at least one of said polyesters, resulting in a depolymerisation product comprising monomers of said polyesters and/or oligomers thereof in a mixture,
2) separating out a fraction containing impurities and/or fillers from this depolymerisation product,
3) subjecting said monomers and/or oligomers to polymerisation, in amounts from 1% to 100% by weight, preferably from 2% to 50% by weight and more preferably from 5% to 30% by weight, with respect to the mixture subjected to polymerisation, resulting in a biodegradable polymer composition,
wherein, in step 1), the said polymer composition comprises at least one polyhydroxyalkanoate and at least one polyester from diacid-diol, and the reaction is carried out at a temperature above the melting temperature of said polyhydroxyalkanoate and wherein additives from the starting mixture of polyesters are fed to polymerisation step 3), together with monomers and/or oligomers, in amounts of up to 5% by weight with respect to the mixture subjected to polymerisation.

2. The process according to claim 1, in which said step 3) of polymerization is carried out keeping the amount of hydroxy acid or its oligomers between 0% and 25% by weight of the total weight of the polymerisation mixture.

3. The process according to claim 1, in which said mixture of polyesters comprises at least one aliphatic-aromatic-type diacid diol polyester.

4. The process according to claim 1, in which said mixture of polyesters comprises at least one aliphatic-type diacid diol polyester.

5. The process according to claim 1, in which said biodegradable composition comprises one or more polyhydroxyalkanoates, one or more aliphatic-type diacid diol polyesters, one or more aliphatic-aromatic-type diacid diol polyesters, and one or more additional polymers comprising one or more vinyl polymers.

6. The process according to claim 1, in which said biodegradable composition comprises one or more fillers.

7. The process according to claim 1, in which said biodegradable polymer composition further comprises polymers of natural origin.

8. The process according to claim 1, prior to step 1, a pre-treatment step that removes said polymers of natural origin from said biodegradable polymer composition comprising a mixture of polyesters.

9. A polymer Polymers obtained by the reuse process according to claim 1.

10. A biodegradable polymer composition comprising the polymer according to claim 9.

11. A biodegradable article comprising said polymer according to claim 9 or said biodegradable polymer composition according to claim 10.

12. The process according to claim 2, in which said mixture of polyesters comprises at least one aliphatic-aromatic-type diacid diol polyester.

13. The process according to claim 2, in which said mixture of polyesters comprises at least one aliphatic-type diacid diol polyester.

14. The process according to claim 2, in which said biodegradable composition comprises one or more polyhydroxyalkanoates, one or more aliphatic-type diacid diol polyesters, one or more aliphatic-aromatic-type diacid diol polyesters, and one or more additional polymers comprising one or more vinyl polymers.

15. The process according to claim 3, in which said biodegradable composition comprises one or more polyhydroxyalkanoates, one or more aliphatic-type diacid diol polyesters, one or more aliphatic-aromatic-type diacid diol polyesters, and one or more additional polymers comprising one or more vinyl polymers.

16. The process according to claim 4, in which said biodegradable composition comprises one or more polyhydroxyalkanoates, one or more aliphatic-type diacid diol polyesters, one or more aliphatic-aromatic-type diacid diol polyesters, and one or more additional polymers comprising one or more vinyl polymers.

17. The process according to claim 2, in which said biodegradable composition comprises one or more fillers.

18. The process according to claim 3, in which said biodegradable composition comprises one or more fillers.

19. The process according to claim 4, in which said biodegradable composition comprises one or more fillers.

20. The process according to claim 5, in which said biodegradable composition comprises one or more fillers.
